(19) United States
(12) Patent Application Publication
(10) Pub. No.: US 2006/0071494 A1
(43) Pub. Date: Apr. 6, 2006

(54) Fender finder with extension and retraction feature

(76) Inventor: Alan S. Ganz, Chicago, IL (US)

Correspondence Address: John W. Hayes, P.O. Box 365, Arlington Heights, IL, 60006-0365, US

(21) Appl. No.: 11/069,840

(22) Filed: Feb. 28, 2005

Related U.S. Application Data
(63) Continuation-in-part of application No. 10/972,996, filed on Oct. 25, 2004.
Application No. 10/972,996 is a continuation-in-part of application No. 10/957,934, filed on Oct. 4, 2004.

(51) Int. Cl. B60R 13/00

(52) U.S. Cl. 296/1.07

(57) ABSTRACT

A fender finder that includes a remotely controlled, extendable and retractable standard portion that offers continuously variable position control. By actuating a switch internal to the vehicle, the vehicle operator may position the standard at an optimum viewing height above the vehicle. When not in use, the standard may be retracted substantially entirely within the vehicle.

### CROSS-REFERENCE TO RELATED APPLICATIONS

This application is a continuation-in-part of U.S. patent application Ser. No. 10/972,996, filed Oct. 25, 2004, which is a continuation-in-part of U.S. patent application Ser. No. 10/957,934, filed Oct. 4, 2004.

### FIELD OF THE INVENTION

This invention relates generally to a device that aids a driver in locating vehicle extremities and in particular to a device that aids in locating the front fenders and hood of a vehicle, and is more particularly directed toward a vehicle-mounted device that aids in locating vehicle front fenders and hood, both to facilitate parking the vehicle and positioning the vehicle properly in its traffic lane while in motion.

### BACKGROUND OF THE INVENTION

For many years, the prominent front-end decoration or “hood ornament” provided on automobiles not only served to identify the vehicle manufacturer, but also provided a reference point for the driver in determining the vehicle's position in the traffic lane while motoring. For many modern automobile models, the hood ornament has been dispensed with, and the loss of this valuable reference point has made the task of maintaining proper position in a traffic lane more challenging for many drivers.

It is not only the loss of the hood ornament that creates position problems for drivers. In the past, automakers sold cars with front fenders that could be seen by the driver. Today, many new car models, particularly mid-size and compact, are designed such that the vehicle front slopes sharply down and away from the driver. In some cases, the driver can only see the windshield wipers. Even for drivers of greater than average height, the leading edge of the vehicle hood cannot be seen at all from the driver's seat. Tall drivers and drivers of medium height can see approximately one foot of the vehicle hood by going through contortions such as draping themselves over the steering wheel and craning the neck in the extreme.

To make matters worse, the front fenders of the car are also invisible. Without a visible marker indicating the center of the hood, and without the driver being able to determine with certainty the precise position of the vehicle fenders, keeping the vehicle centrally positioned within its traffic lane is largely based upon approximation, and parallel-parking the vehicle, even in a spacious parking spot, can be problematic.

There are a number of “fender guide” devices known in the art. For example, U.S. Pat. No. 1,834,682, issued Dec. 1, 1931 to Charles Colstad, describes a guiding attachment for automobiles. This particular type of fender guide is attached to the vehicle by clamping to a fender. The staff of the fender guide is mounted on a pivot so that the orientation of the staff can be adjusted to vertical no matter what angle the base portion makes with the fender. An indicator, such as a bird or an arrow, is screwed on to the top of the staff to make the fender guide easy to see for the driver.

U.S. Pat. No. 2,584,777 issued Feb. 5, 1952 to Mr. George S. Adolfson. Mr. Adolfson's invention is a clearance-indicating arm that is pivotally mounted to the interior of an automobile windshield by a suction cup. The arm is formed from clear plastic and is softly illuminated at night so it can be plainly seen by the driver. In operation, the guide is pivoted into a position parallel with the highway center line, and the operator uses the guide as an aid in preventing drifting of the vehicle across the center line.

U.S. Pat. No. 2,559,761 issued Jul. 10, 1951 to Frank F. Fulton, describes a tractor sight designed to make it easier for a tractor driver to drive the vehicle in a straight line when sighting on a distant indicator (generally a tall post). The sighting portion of Mr. Fulton's invention is generally circular in nature, and includes two spaced-apart vertical bars through which the distant post or marker is viewed by the driver for better alignment. Mr. Fulton's tractor sight uses a U-shaped bracket firmly mounted to the tractor hood, and includes a threaded stud protruding upwardly from the bracket. The vertical rod that supports the circular sight is manufactured in telescoping sections. The interior section is securely threaded onto the stud that projects upward from the mounting bracket, then the height of the circular sight portion above the tractor hood can be adjusted by moving the telescoping rod, then securing the outer-rod in place with respect to the inner rod with the aid of a winged set screw.

U.S. Pat. No. 2,753,439 issued Jul. 3, 1956 to Mr. Alec Greenfield. Mr. Greenfield's patent describes a vehicle clearance guide designed to be mounted directly to the frame surrounding the vehicle headlight. The mounting base is a clamping structure which, in one embodiment, has hook-like features that engage interior and exterior portions of the headlight lens frame. The clearance guide itself is a simple vertical rod fixed to the mounting base with a clamp that allows adjustment of the vertical extent of the rod itself. In another embodiment, the clearance-indicating rod has a light mounted at its top. An electrical connector is provided that is intended to be clipped onto the existing vehicle headlight connector.

U.S. Pat. No. 3,657,821, issued Apr. 25, 1972 to Peter A. De Nure, is directed toward a special vehicle orienting device that is designed to allow the vehicle operator to maintain the vehicle at a fixed distance from a reference line at the right-hand side of the roadway. This is a fairly simple plastic device, preferably spherical in design, that is simply attached to the vehicle hood close to the front of the vehicle. The precise position of this orienting device is dependent upon the particular vehicle operator and the desired distance the operator would like to maintain from the right-hand side of a roadway. The orienting device can also be illuminated by a lamp mounted underneath the vehicle hood, provided that an appropriate reflector and a second transparent opening in the hood are provided to direct light onto the orienting device.

U.S. Pat. No. 3,858,924 issued Jan. 7, 1975 to John F. Bores. This patent describes a truck bumper guide that can be mounted by a clamp-type mounting base that is easily affixed to the outward extremities of a truck bumper. The mounting base clamps a vertical mounting sleeve securely to the truck bumper. A vertical standard, including a light at the top for easy viewing by the driver, simply slides into the sleeve for proper mounting.

U.S. Pat. No. 4,016,653 issued Apr. 12, 1977 to Joseph E. Bartlett. This patent is directed toward another type of sighting device for a vehicle, which in this case is a telescoping shaft that is pivotally mounted at one end to the vehicle dashboard. The other end of this telescoping member supports a sight through which the operator can view the roadway centerline. The mounting shaft for this sight pivots and telescopes so that the position of the sight can be precisely adjusted.

U.S. Pat. No. 4,070,645, issued Jan. 24, 1978 to Mr. Jerome Oreluk, is directed toward a device designed for connection to the vehicle using the mounting holes for the front license plate. The device itself is a rod, mounted such that it extends slightly forward of true vertical. The device includes an electrical switch that is activated if the rod is moved toward the vertical position. The switch is normally coupled to the vehicle horn to give an audible indication of contact with a bumper of a vehicle in front. It can readily be appreciated that this device is intended to act as an aid in parking a vehicle when the precise location of the vehicle front bumper cannot easily be determined by the vehicle operator.

U.S. Pat. No. 4,928,393 issued May 29, 1990 to Wilbur Van Schaack. This patent is directed toward a lane marker steering guide designed to be mounted to the interior of a vehicle windshield using a suction cup. The operator of the vehicle simply sights along this indicator device to the road edge marker on the right-hand side of the highway, and maintains this position in order to keep the vehicle in the desire lane. There are a number of embodiments described, including the use of multiple suction cups and other adjustment features to allow the indicator to be repositioned for various drivers of the vehicle.

U.S. Pat. No. 5,094,001 issued Mar. 10, 1992 to Rodney Fraser, and is directed toward a transversely extending sighting device designed to be mounted to the hood of a tractor. The horizontally disposed rod is telescopically extendable and includes sighting markers disposed along its length to assist in navigating various courses through a field.

U.S. Pat. No. 5,826,966 issued Oct. 27, 1998 to John Schwing. This particular patent is directed toward a lighted bumper guide that has a base portion designed to be affixed to the bumper of a vehicle. The base portion includes a light source, and the vertical portion that attaches to the base includes a fiber optic filament to direct illumination.

U.S. Pat. No. 2,218,486 issued Oct. 15, 1940 to Mr. William Storrie. This invention is a fender guide designed to be mounted to a vehicle fender so that it extends both vertically and in a forward direction from its mounting point. This forward inclination is incorporated so that an indicator at the top of the shaft (visible to the operator of the vehicle) will be positioned at a point that is directly above the forward portion of the vehicle that is furthest from the driver. This method of identifying the furthest extremity of the vehicle is particularly useful when parking the vehicle in a small parking place closely bounded by other vehicles.

U.S. Pat. No. 2,553,963 issued May 22, 1951 to Mr. William Dzus. This patent is directed toward yet another steering guide designed for vehicles. Rather than being mounted along the vehicle centerline at the front of the vehicle, this particular steering guide is mounted on the vehicle hood directly in front of the driver. The inventor asserts that this particular mounting arrangement makes it much easier for the driver to accurately control the vehicle's position along the roadway.

The fender guides and aiming devices of the prior art are difficult or impossible to mount on modern auto bodies, particularly those with a high plastic or composite content in the front bumpers and fenders, and, since most of the devices in the art were developed long ago, they would not be considered esthetically pleasing today. Consequently, a need arises for a device that will aid the driver in determining the precise extent of the vehicle when parking (and when driving, particularly when navigating along narrow thoroughfares), and that will help establish a reference to ease the task of positioning the vehicle properly within its traffic lane when driving down the highway. The device should be unobtrusive, relatively low in cost, and both efficient and inexpensive of installation.

### SUMMARY OF THE INVENTION

These needs and others are satisfied by the fender finder of the present invention, which includes an electrically operated drive assembly positioned proximate a vehicle extremity, a standard portion operably installed in the electrically operated drive assembly, and a dedicated control switch installed within the vehicle and electrically interconnected with the electrically operated drive assembly. Operation of the dedicated control switch by a vehicle operator provides continuously variable extension of the standard portion to position the standard at an optimum height above the vehicle, thus aiding the operator in determining location of the vehicle extremity.

In one form of the invention, the electrically operated drive assembly is disposed substantially within the vehicle body, proximate the vehicle extremity to be located. Preferably, a portion of the electrically operated drive assembly extends through an opening in the vehicle body proximate the vehicle extremity to be located.

In accordance with one aspect of the present invention, the standard portion comprises a telescoping standard. The standard portion may be coupled to the electrically operated drive assembly via a flexible portion. Preferably, the flexible portion is affixed, proximate a first end, to an innermost section of the telescoping standard. The flexible portion may also be coupled to a drive gear internal to the electrically operated drive assembly. The flexible portion is coupled to the drive gear by mating gear teeth on the flexible drive portion and the drive gear.

In another form of the invention, the standard portion comprises a one-piece standard. The one-piece standard may be coupled to the electrically operated drive assembly via a flexible portion. In the alternative, the one-piece standard may be coupled to the electrically operated drive assembly via a pair of opposing drive rollers. The electrically operate drive assembly may further comprise a pair of opposing guide rollers in operational contact with the single-piece standard. The one-piece standard may further comprise a stop feature constructed and arranged to contact the guide rollers to forestall over-extension of the standard.

In another aspect of the invention, the dedicated control switch comprises a three-position control switch. The three-position control switch includes a first position that actuates the electrically operated drive assembly in a first direction, extending the standard portion outwardly from the electrically operated drive assembly. The three-position control switch also includes a second position that actuates the electrically operated drive assembly in a second direction, retracting the standard portion in a direction toward the electrically operated drive assembly.

Further objects, features, and advantages of the present invention will become apparent from the following description and drawings.

### BRIEF DESCRIPTION OF THE DRAWINGS

FIG. 1 is a top plan view of a portion of an automobile, from the windshield to the front extremity;

FIG. 2 is a side elevational view of the automobile portion illustrated in FIG. 1;

FIG. 3 is a top view of a vertical standard in accordance with the present invention;

FIG. 4 is a side view of the vertical standard of FIG. 3;

FIG. 5 is a top view of a receiver in accordance with the present invention;

FIG. 6 is a side view of the receiver of FIG. 5;

FIG. 7 is a section view taken along section lines 7-7 of FIG. 5;

FIG. 8 is a cutaway view of a portion of a vehicle bumper illustrating installation of the receiver of FIG. 6;

FIG. 9 is a top view of a plastic cap;

FIG. 10 is a side view of the plastic cap of FIG. 9;

FIG. 11 depicts an alternative configuration in accordance with the present invention;

FIG. 12 is a side view of a spacer;

FIG. 13 is an end view of the spacer of FIG. 12;

FIG. 14 is a top plan view of an alternative embodiment of a receiver portion in accordance with the present invention;

FIG. 15 is a front elevational view of the receiver portion of FIG. 14;

FIG. 16 is a side elevational view of the receiver portion of FIG. 14;

FIG. 17 illustrates measurement of a contour of an external vehicle surface;

FIG. 18 depicts a receiver portion having a shaped mounting surface in accordance with the present invention;

FIG. 19 illustrates a fender finder, in accordance with one embodiment of the present invention, in its mounting position on an exterior vehicle surface;

FIG. 20 is a side elevational view of the front portion of a vehicle;

FIG. 21 is a top plan view of the vehicle portion of FIG. 20;

FIG. 22 is a cutaway view of an extendable and retractable standard in accordance with another alternative embodiment of the present invention;

FIG. 23 is a cutaway view of a standard extension and retraction assembly in accordance with the present invention;

FIG. 24 depicts installation of the assembly of FIG. 23 on a vehicle;

FIG. 25 illustrates a control panel;

FIG. 26 is a side view of the control panel of FIG. 25; and

FIG. 27 is a cutaway view of a standard extension and retraction assembly in accordance with another alternative embodiment of the present invention.

### DETAILED DESCRIPTION OF THE INVENTION

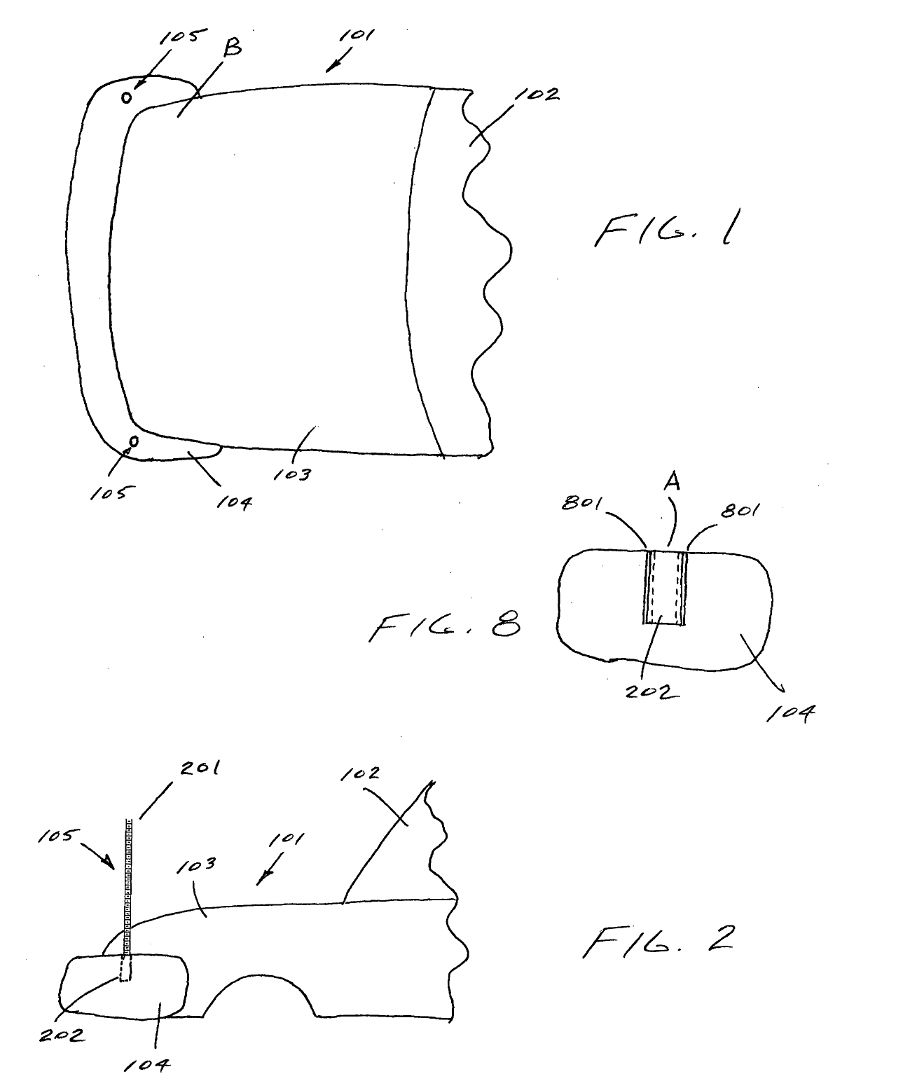

There is described herein a fender finder that offers distinct advantages when compared to the prior art. FIG. 1 is a top plan view of a portion of an automobile 101 that includes a hood portion 103 that slopes rapidly down and away from the driver's position behind the windshield 102, thus depriving the driver of any view of the hood or fenders. This particular vehicle hood 103 does not have a hood ornament.

The bumper 104 is of the type commonly employed on automobiles manufactured in recent years. Generally, these bumpers 104 are non-metallic, plastic composite constructions that may have a substantial layer of a foam material surrounded by thin plastic. The plastic covering does not contribute materially to the structural integrity of the vehicle bumper 104, but is primarily present for appearance sake. The vehicle illustrated in FIG. 1 is equipped with two fender finders 105 in accordance with the present invention.

FIG. 2 is a side elevational view of the automobile portion 101 illustrated in FIG. 1. One of the fender finders 105 is clearly visible in this view, and it will be appreciated that the fender finder 105 generally comprises two portions: a vertical standard portion 201 and a receiver portion 202.

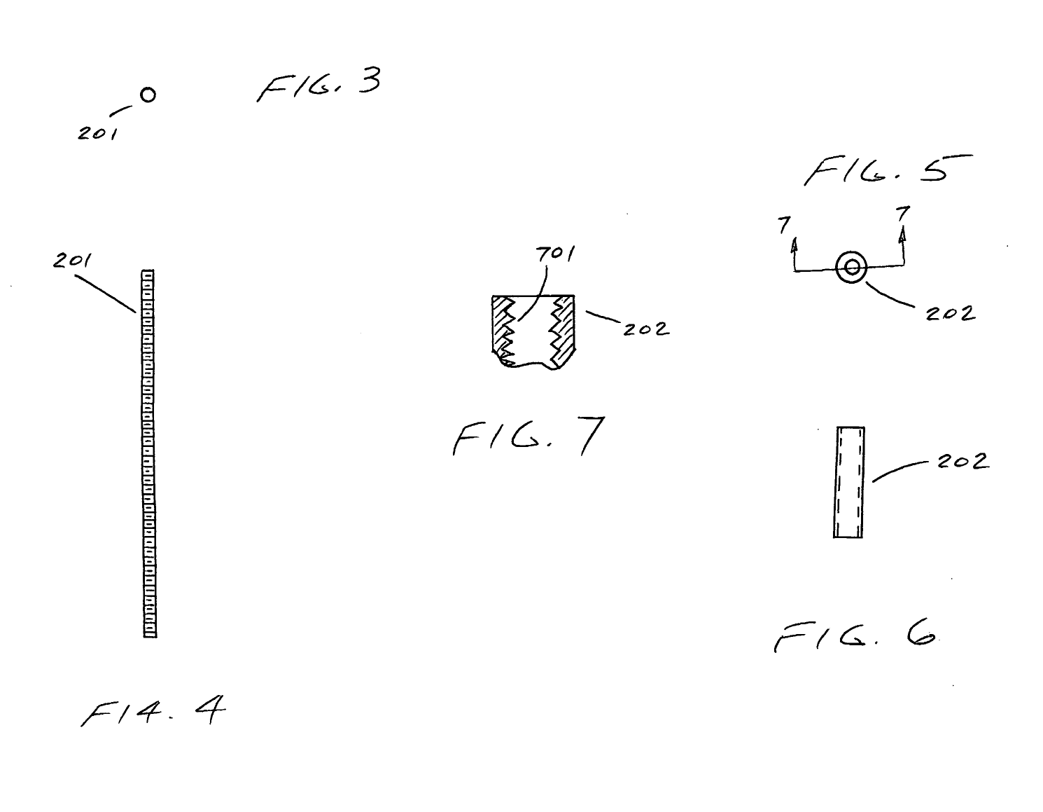

FIGS. 3 and 4 illustrate the standard 201 in greater detail. Preferably, the standard 201 is a solid non-metallic rod with an exterior thread. In one embodiment, the rod is fiberglass, but the rod may also be formed from a suitable plastic compound, for example, and the thread on the exterior surface may be extended over the entire length of the standard 201 for ease of manufacture. Of course, it is entirely possible to fabricate the standard from other suitable materials, such as a metal like stainless steel, for example, and it is equally possible to make the standard in the form of a hollow tube rather than a solid rod. However, there are a number of design considerations involved, such as weight, material and manufacturing costs, and wind resistance when a vehicle equipped with a fender finder 105 is driving down the highway at normal speed.

In any event, the color of the standard 201 is preferably white, or at least a light color so that the standard will be readily visible to the driver 201. If the standard 201 is plastic, it can be formed from a plastic material of the desired color. In the alternative, the standard 201 may be dipped, painted, coated, or otherwise imbued with any desired color, and a flag, pennant, or ornament may be affixed to the upper extremity of the standard at the user's discretion. An illuminated or reflectorized tip could even be added for enhanced visibility.

As noted with reference to FIG. 1, the standard 201 is installed into the receiver portion 202, which is illustrated in more detail in FIGS. 5 through 7. Preferably, the receiver 202 is formed from a sturdy non-metallic material, such as fiberglass or a suitable plastic composition, for example, and is provided with threads 701 in its interior. The threads may extend for the entire length of the receiver 202 or may end abruptly. In fact, although not illustrated in the drawing figures, a threaded portion (such as a nut) may simply be attached to the open end of the receiver, thus obviating interior threading of the receiver portion 202.

Of course, it may be advantageous to provide a ridge of material at the thread termination within the receiver body, to act as a stop for the standard (201 in FIG. 4), but this is not a requirement (and is not shown in the figures). It is also possible to add a lock nut on the standard itself, to be tightened against the receiver 202 when the standard is in its installed position, but this is also not required and is not illustrated. Another possible expedient is the introduction of an adhesive to the threads of the standard 201, or the threads of the receiver 202, so the standard 201 will resist backing out of the receiver portion 202.

For ease of manufacture and cost considerations, the standard 201 itself is preferably cut to a length of 3 feet 6 inches. Of course, it is a simple matter to adjust the height of the standard 201 to suit a particular vehicle installation, by simply trimming off the excess. If the standard 201 is threaded throughout its length, then the threads themselves provide a convenient cut mark for any trimming that the installer may consider necessary.

FIG. 8 is a view of the receiver 202 in its installed position within the vehicle bumper 104. For installation, a hole is drilled in the vehicle bumper (or other suitable region near the front of the vehicle) to a depth of 6 inches, which is the overall length of the receiver portion 202 as supplied. Of course, the length of the receiver can be adjusted, and the hole-drilling procedure modified for any particular installation. It is entirely possible that 6 inches for the receiver 202 might be excessive for some vehicles. In any event, the hole in the vehicle structure is drilled such that, when installed, the upper edge of the receiver 202 will be flush with (or slightly below) the upper surface of the vehicle bumper 104.

After the hole in the bumper 104 (or other suitable portion near the front of the vehicle) has been prepared, a strong adhesive, such as an epoxy-based adhesive, is applied both to the outside of the receiver 202 and the interior of the hole in the bumper 104. The receiver 202 is inserted into the hole and the adhesive 801 is allowed to dry thoroughly before the standard 201 is threaded into place.

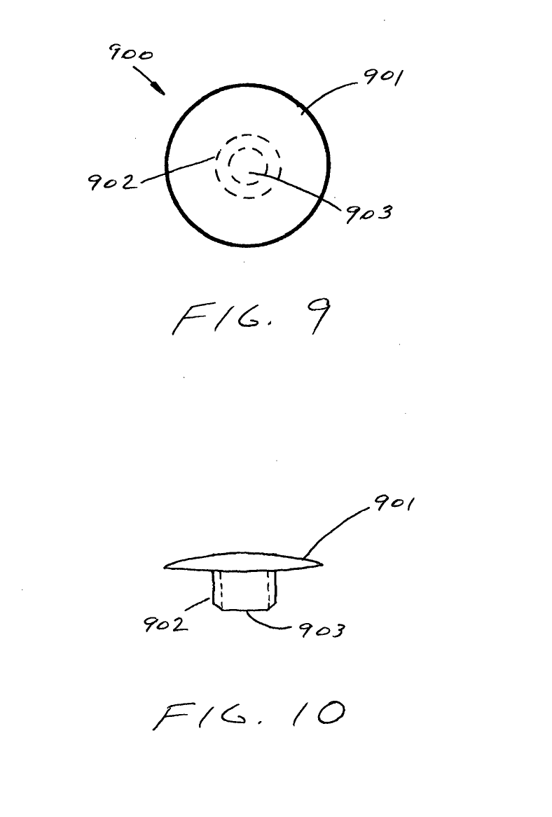

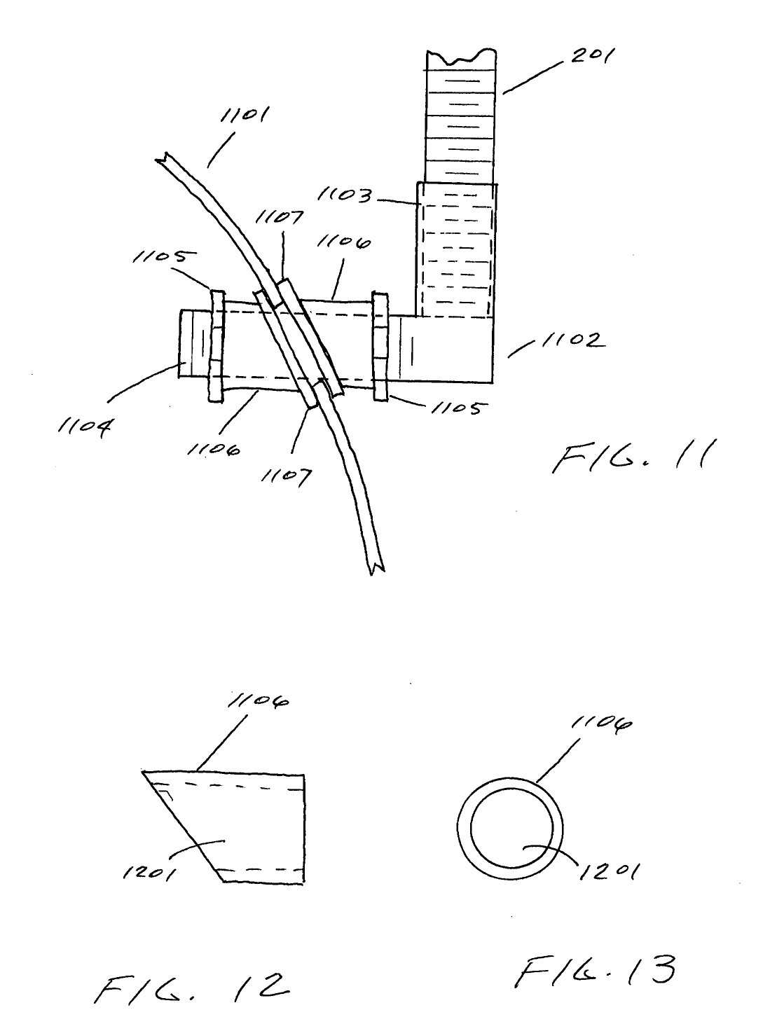

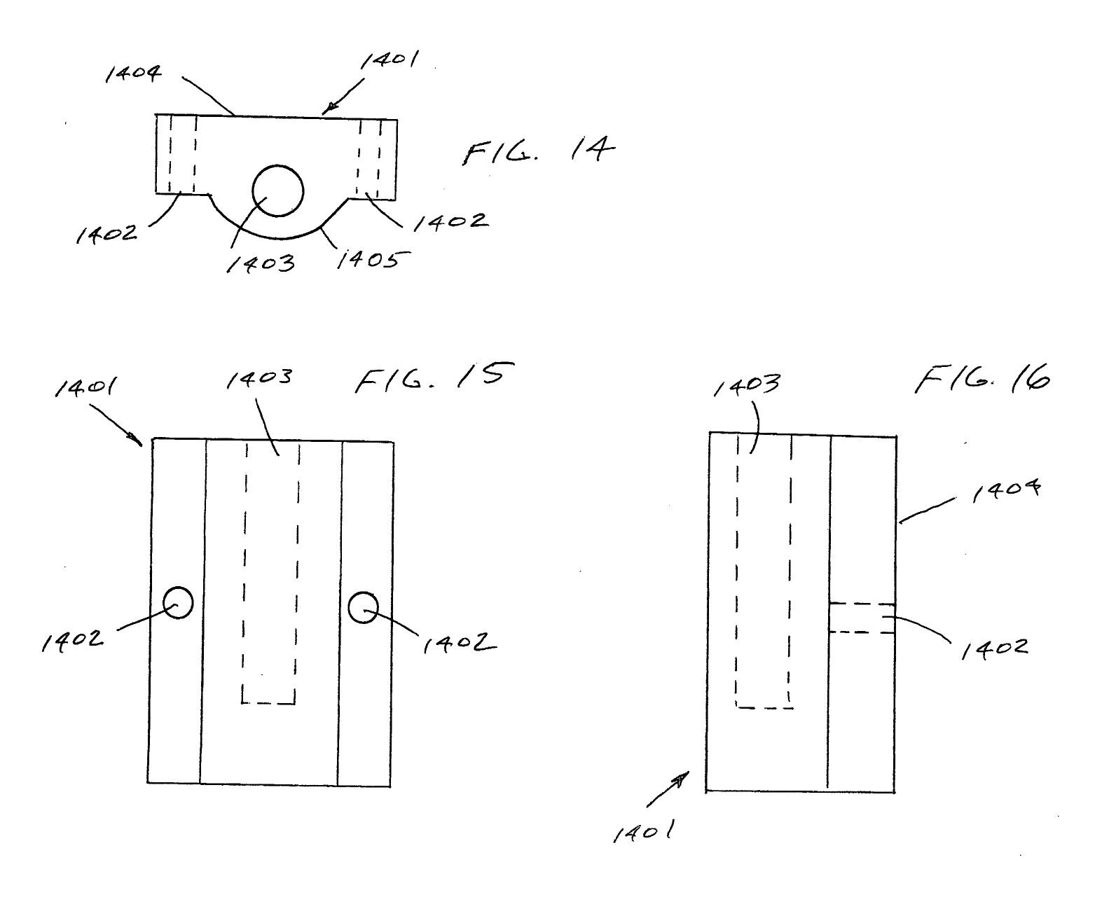

Of course, a powerful adhesive such as epoxy resin is nearly impossible to remove. Consequently, should the vehicle operator wish to discontinue use of the fender finder, the standard 201 may be unscrewed and removed. To cover the opening in the bumper 104, and the receiver 202 itself, cap 900 as illustrated in FIGS. 9 and 10 may be used. Preferably, the cap 900 is formed from a relatively flexible material, such as nylon, but the cap could be fabricated from other suitable materials, such as fiberglass, for example. As shown, the cap 900 includes an upper circular portion 901 having a great enough diameter to cover the opening in the bumper. A portion 902 extending downwardly from the upper portion 901 should provide a press fit into the threaded interior of the receiver 202 (FIG. 8), completely covering the opening A (FIG. 8). Of course, the cap 900 may also be threaded so it can screw into the receiver 202, although this is not illustrated in the drawings.

Returning to FIGS. 9 and 10, there is preferably an opening 903 provided in the downwardly extending portion 902 to enhance deformability. Of course, the cap 900 may be affixed in position using an adhesive. As an alternative, the cap may be replaced by a bolt having a thread that matches the thread of the receiver 202, although this alternative is not shown in the drawings. The bolt could be formed from metallic or non-metallic material.

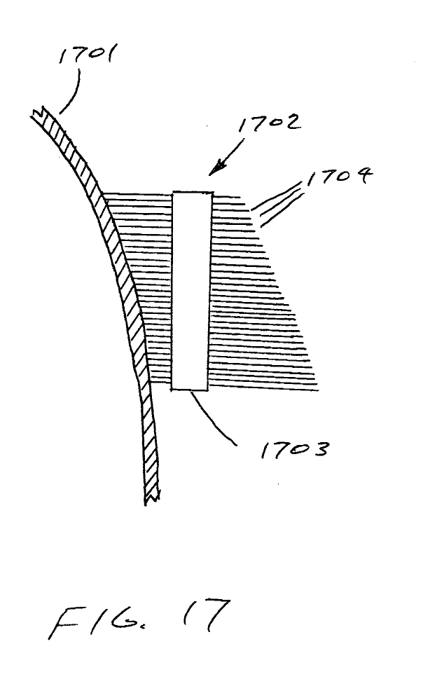

FIG. 11 illustrates another mounting configuration for the fender finder. In this exemplary embodiment, the decision is made to attach the fender finder to the sloping exterior of the vehicle fender in a position proximate the front of the vehicle. This positioning is contemplated in cases where it is not feasible to attach the fender finder directly to the vehicle bumper.

In the mounting detail of FIG. 11, a right-angle receiver 1102 is used to accommodate the vertical standard 201. The right-angle receiver 1102 is preferably formed from fiberglass, a suitable plastic composition, or other durable non-metallic material, but metal, such as stainless steel, may be preferred for some installations. This right-angle receiver 1102 is substantially L-shaped, with a receiver arm oriented vertically and designed to accept the standard 201, and an installation arm oriented horizontally and designed to be inserted through an opening in the vehicle. Just as described previously, the receiver arm has a vertical portion with internal threads 1103 designed to accommodate the exterior threads of the standard 201.

In operation, an opening is made in the vehicle fender 1101 and the horizontal portion of the receiver 1102 is inserted through the opening. Prior to inserting the receiver 1102, a lock nut 1105 is turned onto the threaded horizontal shaft, a specially cut spacer 1106 is placed on the horizontal shaft of the receiver, and these are followed by a sealing grommet or washer 1107. This grommet or washer 1107 may be formed from rubber or other resilient material so that the grommets 1107 provide a sealing action.

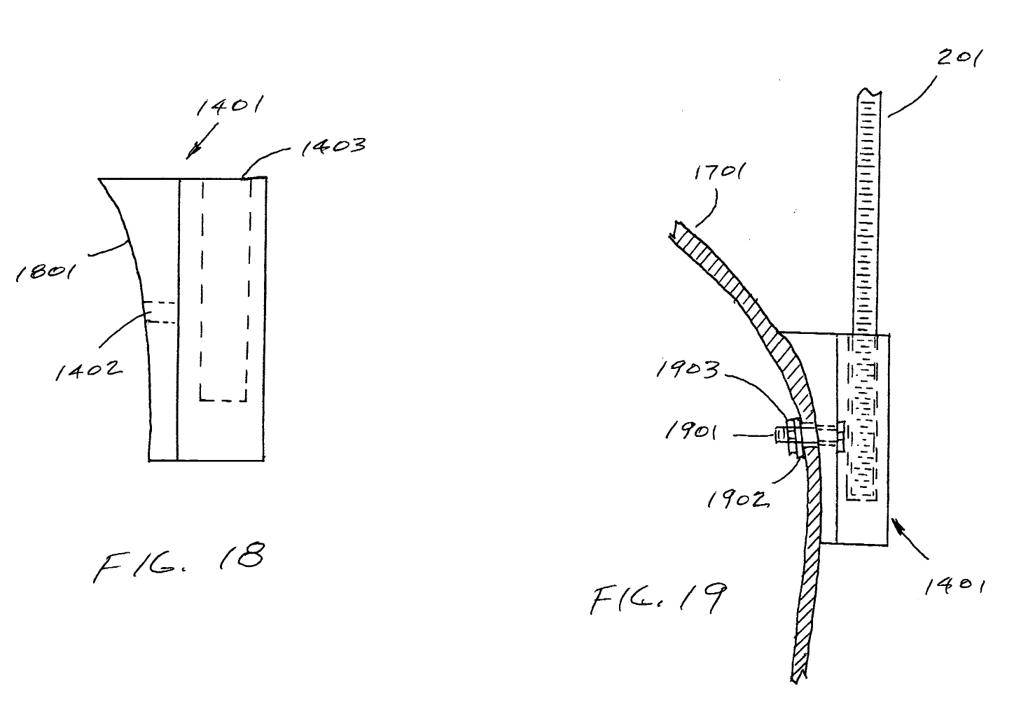

The spacer 1106, illustrated in greater detail in FIGS. 12 and 13, may also be formed from plastic material, and is cut at an angle corresponding to the angle the fender 1101 makes with the vertical at the point where the opening is made. This specialized angle is necessary in order that the standard 201 will be as nearly vertical as possible when installed. Of course, the spacers 1106 may also be formed from a suitable metallic material.

After the horizontal portion of the receiver 1102 is inserted through the opening, another grommet or washer 1107, spacer 1106, and nut 1105 are placed on the horizontal shaft, and the whole is tightened firmly using the nuts 1105. Thus, the receiver 1102 is firmly fixed in position, and the standard 201 may be installed as described above for the prior embodiment.

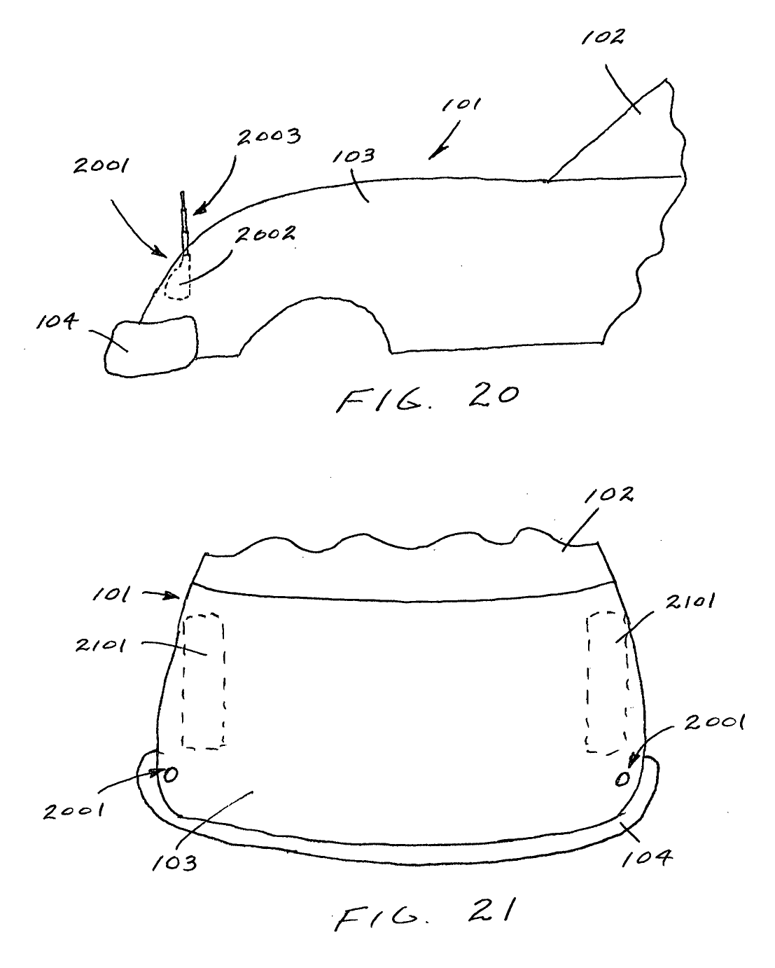

Of course, there may be vehicles for which it is impracticable to mount the fender finder of the present invention to the vehicle bumper, and it may be undesirable to use the alternative installation illustrated in FIG. 11. For installations such as this, an alternative receiver 1401 as shown in FIGS. 14-16 is preferred.

The receiver 1401 is preferably formed from a durable material, such as fiberglass or plastic. The shape illustrated in FIGS. 14-16 has a contoured outer surface 1405, but the receiver 1401 may also be formed as a rectangular solid or a cylindrical solid, for example, although these shapes are not illustrated in the drawings. The receiver 1401 is provided with pre-formed mounting holes 1402, and is also provided with an opening 1403 drilled or formed into the receiver 1401 and threaded along its interior surface to accommodate a standard (201 in FIG. 4) just as for previously described embodiments. Only two mounting holes 1402 are provided in the illustrated embodiment, but more mounting holes 1402 may be provided if desired.

The receiver 1401 is provided with a mounting surface 1404 that is intended to be shaped in accordance with a contour of an exterior surface of the vehicle on which the receiver 1401 is to be installed. FIG. 17 illustrates a cross section of a portion of a vehicle fender 1701 in proximity to the front bumper of the vehicle (such as illustrated by position B of FIG. 1). One way to replicate the contour of the vehicle surface 1701 is to employ a contour gauge 1702 as is well-known in the art. A contour gauge 1702 generally comprises a plurality of steel pins 1704 disposed in parallel and lying in the same plane. The pins 1704 are held in place by a frame 1703 that gently retards motion of the pins 1704, so that the pins will remain in place after a surface contour is measured. Of course, there are some models of contour gauge 1703 in which the pins 1704 move with relative freedom, then are locked in place after the surface measurement is made.

Once the shape of the desired mounting area has been measured, the mounting surface 1404 of the receiver 1401 is shaped in conformance with the measured contour. FIG. 18 illustrates the receiver 1401 with a re-shaped mounting surface 1801 that conforms to the shape of the desired mounting area on the vehicle. There are a number of ways of transferring the shape measured by a contour gauge 1702 to a work piece. One workable method is to use a table router with a follower arm designed to trace the shape provided by the contour gauge 1702. This is a well-known technique similar to the way in which keys are duplicated. Of course, the shape measured by the contour gauge may also be transferred to the receiver 1401 by simply marking the receiver 1401 with a pencil or other marking implement in conformity with the measured contour, then shaping the receiver 1401 accordingly. This shaping process may be conducted with a router, plane, rasp, or other shaping tool known in the art.

The shaped receiver 1401 is then installed on the vehicle surface with bolts 1901 inserted through the openings 1402 and through openings made in the vehicle surface by an installer. Washers 1902 may be applied over the bolts 1901 and the receiver 1401 secured in position with nuts 1903. As noted previously, more than two mounting holes 1402 may be provided in the receiver 1401 for added mounting security. It is also possible to use mounting flanges or brackets with the receiver 1401, although these expedients are not illustrated in the drawings. It may also be desirable to interpose a gasket of resilient material between the receiver 1401 and the vehicle surface 1701, but this is also not shown in the drawing figures.

In any event, after the receiver 1401 is secured to the vehicle surface 1701, the standard 201 is threaded into the opening 1403 provided in the receiver 1401, just as noted above in conjunction with the descriptions of other embodiments of the invention. The standard 201 may then be trimmed to the desired length. The standard 201 may also be removed, if desired, and the opening in the receiver may be capped as described above.

For some users of the fender finder system as described above, it may be desirable to be able to retract and extend the fender finder remotely. This feature may become useful under a variety of circumstances. For example, the vehicle operator may not wish to subject his vehicle to an automated car wash with the vertical standard of the fender finder extending upwardly from the vehicle. There is a possibility that the automated car wash could adversely affect the fender finder installation, or even cause damage to the vehicle, and it is even likely that the operator of the automated car wash system may have a prohibition against allowing vehicles equipped with fender finder standards to enter the car wash.

Of course, the fender finder standards in the embodiments described above are removable, but generally require the vehicle operator to unscrew the standard portions in order to dismount them, and to install appropriate plugs to ensure that any exposed openings are properly closed off. This necessity to manually remove the standard portions of the fender finder assemblies may be difficult for some vehicle operators.

In a case where a vehicle is shared among family members, some drivers may not wish to use the fender finder feature, and a method for quickly and efficiently hiding the fender finder standards from view would be desirable under these circumstances. It would also be desirable to have the capability to restore fender finder operation in the same quick and efficient manner. In addition, some drivers feel uncomfortable leaving a vehicle unattended with the fender finder's standards extended, because of the possibility of vandalism or inadvertent damage to the extended upright portions.

FIG. 20 is a side view of a portion of a vehicle 101 depicting the vehicle hood 103, windshield 102, and front bumper assembly 104. A retractable and extendable fender finder assembly 2003 is shown installed in one suitable position proximate the left front fender of the vehicle 101. The retractable and extendable fender finder assembly 2003 includes an electrically operated drive assembly 2002 coupled to an extendable and retractable standard 2003.

FIG. 21 is a top view of the vehicle of FIG. 20. Two fender finder assemblies 2001 are shown installed proximate the front extremities of the vehicle 101. Preferably, the fender finder assemblies 2001 are installed such that adequate clearance is provided for movement of the front tires 2101 during vehicle maneuvering.

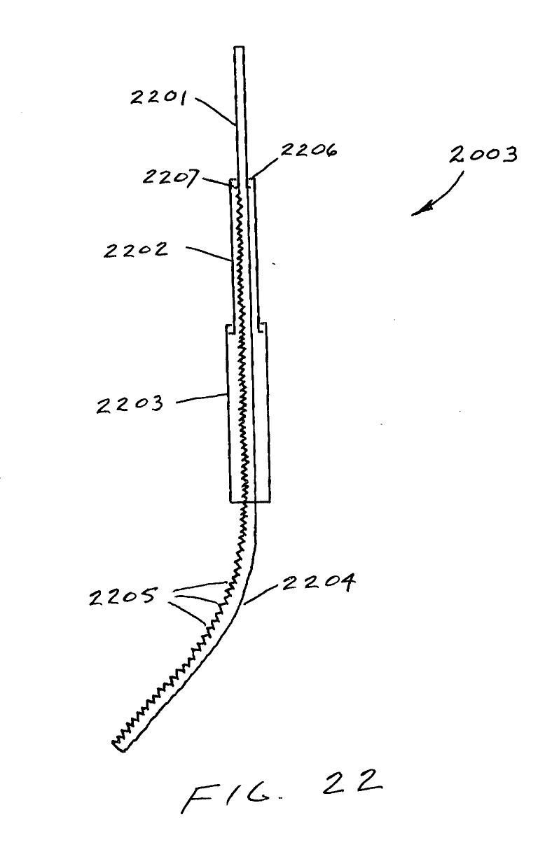

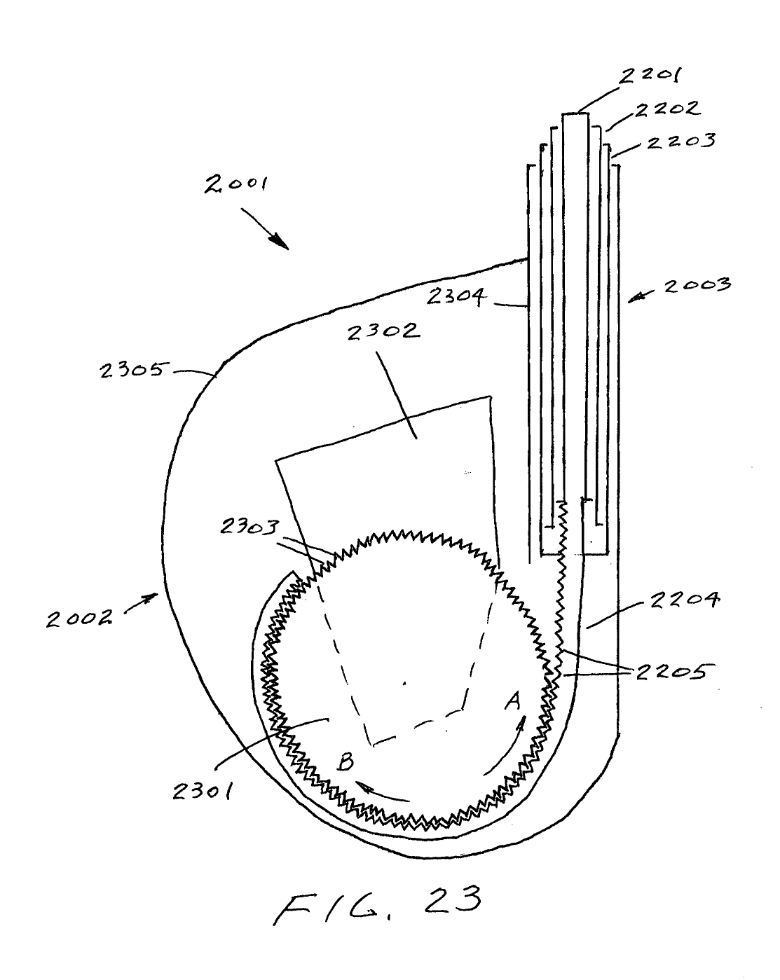

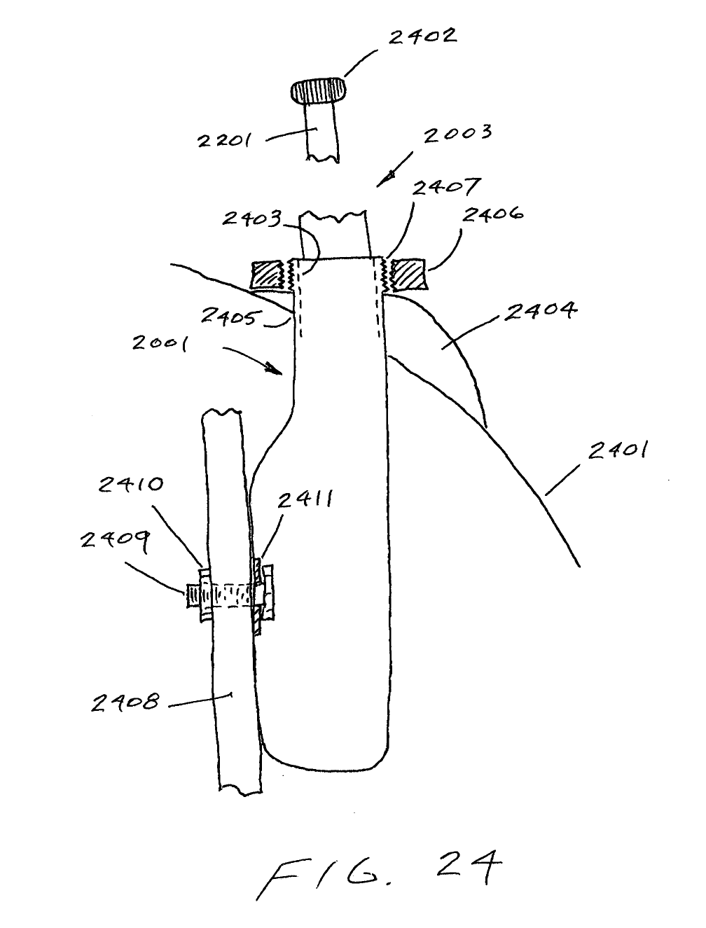

FIG. 22 shows operational features of the retractable and extendable standard 2003 of the fender finder. Three sections 2201-2203 are illustrated in the drawing, although a different number of sections could be implemented depending upon the specific vehicle application. In the preferred embodiment, extension and retraction of the standard 2003 is controlled remotely from the vehicle interior, in a manner to be described subsequently.

The extendable and retractable standard portion 2003 as depicted in FIG. 22 includes a first telescoping portion 2203 of sufficient diameter to house the remaining sections 2201-2202. The telescoping sections 2201-2203 are preferably formed from steel or other suitable metallic material, and finished with a smooth, bright finish utilizing a plating process, for example. Each telescoping section, such as section 2202, for example, is provided with a fluted or flared portion 2206 constructed and arranged to engage with a mating portion 2207 on the telescoping section 2201 that fits inside it. In this way, the telescoping sections are restrained from disengaging with one another, and instead cooperate in a slidable fashion.

In order to implement the telescoping feature of the standard 2003, a flexible portion 2204 is firmly affixed to the innermost telescoping section 2201. This flexible portion 2204 is preferably formed from a thermoplastic composition, such as nylon, or other flexible, resilient material having suitable structural integrity. The flexible portion 2204 preferably has integrally formed serrations or teeth 2205 that operably engage with a drive mechanism to be described in detail below. When the flexible portion is manipulated by the drive mechanism, the telescoping standard 2003 is extended or retracted.

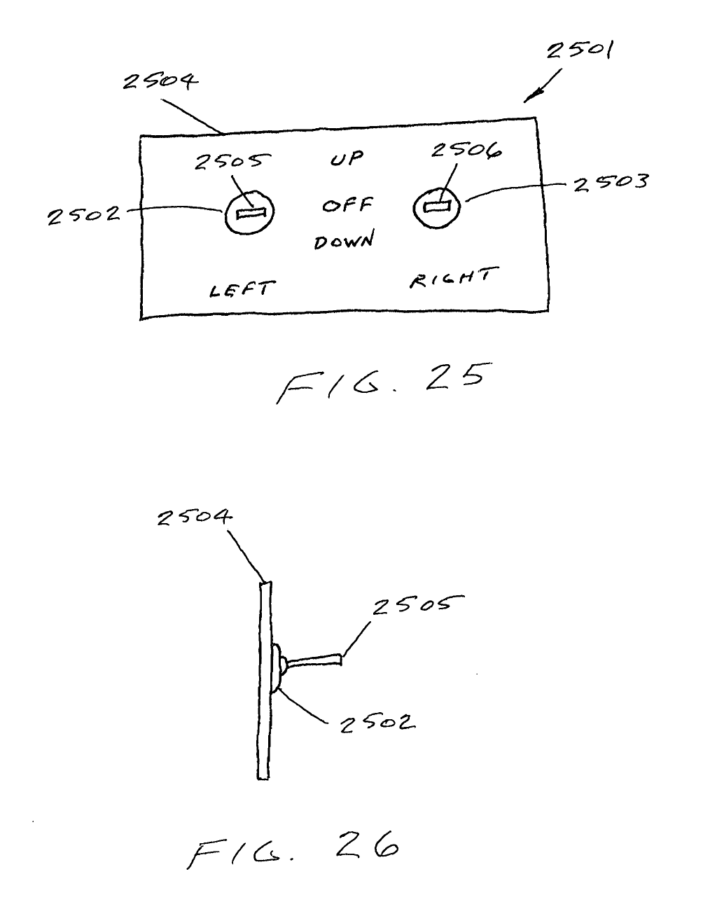

FIG. 23 is a detailed view of the extendable and retractable fender finder 2001. A housing 2305, which may be of metal or durable plastic construction, for example, includes a guide cavity 2304 that accommodates the extendable standard 2003. The outermost section 2203 of the extendable standard 2003 slides into the guide cavity 2304 and is preferably affixed in place by a nut that is secured to a mating threaded region on an extended portion of the guide cavity 2304, although this detail is not illustrated in the figure. This fender finder installation methodology allows the extendable standard 2003 to be replaced with relative ease should circumstances require.

As noted previously, the flexible portion 2204 of the standard 2003 plays an important role in the extension and retraction operation for this exemplary embodiment, although other coupling techniques connecting the standard 2003 to the drive mechanism may also be workable. In the illustrated embodiment, the flexible portion 2204 is coupled to a drive gear 2301 such that the teeth 2205 of the flexible portion are in operational engagement with mating teeth 2303 on the drive gear 2301.

An electric motor 2303, mounted within the housing 2305, provides motive power for the drive gear 2301 in response to remotely applied control signals in a manner that will be described subsequently. When the electric motor 2302 acts to propel the drive gear 2301 in the direction of arrow A, the flexible portion 2204 that is coupled to the innermost section 2201 of the standard 2003 acts to extend the standard 2003. When the drive gear 2301 is rotated by the electric motor 2302 in the direction of arrow B, the flexible portion 2204 is drawn back into the housing 2305 and the standard 2003 then retracts.

As noted above, the standard 2003 may include a different number of sections than those illustrated. For example, a one-piece standard may be implemented using the flexible portion 2204 to extend and retract it. Other drive mechanisms are also contemplated. FIG. 27 illustrates a drive mechanism constructed from opposing, electrically-driven rollers 2705 that can easily extend and retract a one-piece standard 2701.

A housing 2707 provides support for an electric motor assembly 2703 that is operationally coupled to a pair of opposing drive rollers 2705. The drive rollers are preferably formed from a resilient material, such as hard rubber, for example, that will compress slightly against the standard 2701. In the alternative, the drive rollers 2705 may be constructed of any suitable material and may simply employ an outer portion of compressible material.

The standard 2701 may extend through an open bottom portion of a guide cavity 2704 when retracted. Of course, the guide cavity 2704 may also be sealed, if desired, provided it extends downwardly a sufficient amount to house the retracted standard 2701. A pair of opposing guide rollers 2706 is also illustrated. These guide rollers 2706 may aid in ensuring that the standard 2701 is firmly supported throughout its range of travel, and it is not necessary that the guide rollers 2706 be coupled to any drive mechanism. The guide rollers 2706 may simply be free to rotate. The standard 2701 may also be equipped with a stop feature 2702 that is designed to engage with the guide rollers 2706 to forestall over-extension of the standard 2701.

FIG. 24 illustrates an exemplary mounting for the fender finder assembly 2001 in accordance with the present invention. A suitable mounting hole 2405 is first provided in the vehicle body 2401. The mounting hole should preferably be positioned as close as possible to a front fender of the vehicle. The fender finder assembly 2001 is then inserted through the opening 2405 from an interior position.

The fender finder assembly 2001 may be secured to an interior vehicle structural feature 2408. A mounting bracket or tab 2411 may be secured to the housing of the fender finder to facilitate this mounting technique. A bolt 2409 is simply inserted through an opening in the structural feature 2408 and secured by a nut 2410.

If desired, an escutcheon or cover plate 2404 may be placed over the protruding portion of the fender finder assembly 2001 to cover the opening 2405 in the vehicle body 2401. The use of an escutcheon 2404 will help keep moisture and other contaminants from the opening 2405. Preferably, the escutcheon 2404 is designed to provide a relatively flat surface generally perpendicular to the standard 2003 of the fender finder assembly 2001 to accommodate a nut 2406 that secures the upper portion of the fender finder assembly 2001 in position. A threaded region 2407 may be provided on an exterior surface of the fender finder assembly 2001 to accommodate the nut 2406.

FIG. 24 also depicts a grommet 2402 affixed to the end portion of the interior section 2201 of the standard 2003. When the standard 2003 is fully retracted, the grommet 2402 fits inside the opening 2403 at the extreme end of the fender finder assembly 2001. The grommet 2402 is preferably formed from a resilient material that provides sealing action when the standard 2003 is fully retracted, helping to keep dirt, moisture, and other contaminants from the interior of the fender finder assembly 2001.

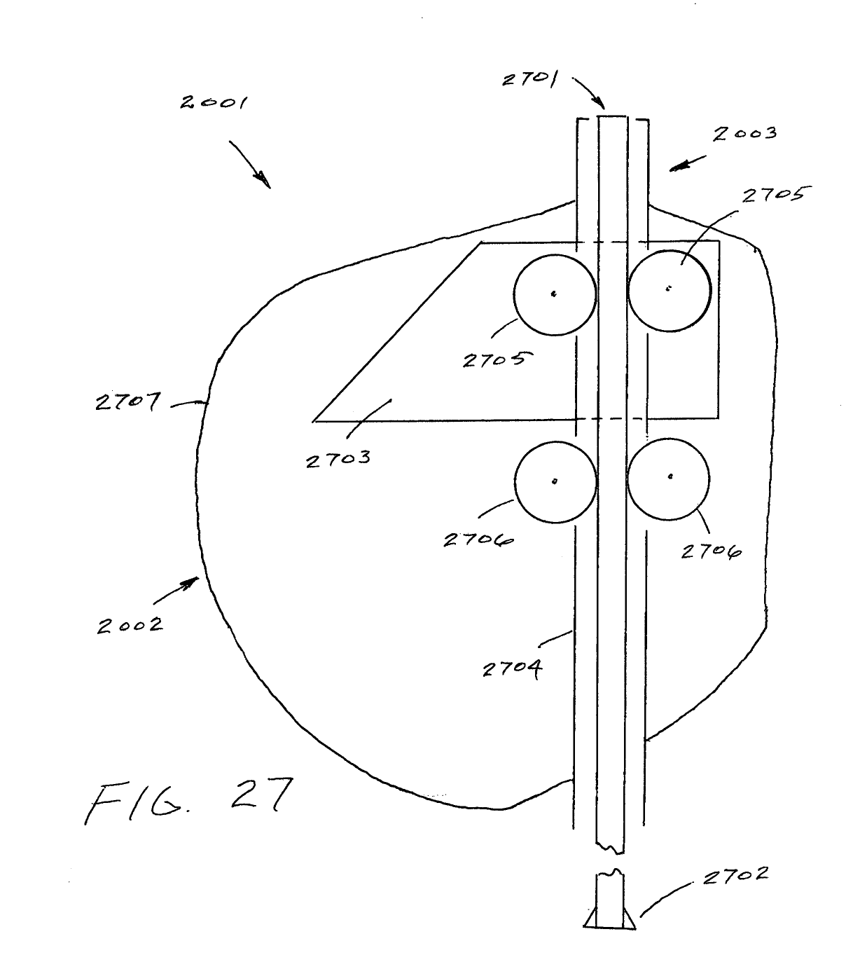

FIGS. 25 and 26 illustrate a control panel 2501 through which the vehicle operator transmits control information to the fender finder assemblies 2001. The control panel 2501 includes a front panel 2504 with various legends that indicate the proper directions in which to move the control switches 2502, 2503. For example, in the illustrated embodiment, switch 2502, with actuator toggle 2505, controls the fender finder assembly 2001 mounted near the left front extremity of the vehicle.

When the actuator toggle 2505 is moved in an upward direction, the standard 2003 of the corresponding fender finder 2001 extends outwardly from its corresponding electrically operated drive assembly 2002, and continues to extend so long as the toggle 2505 is maintained in the UP position. Preferably, the switch 2502 is spring biased such that the switch toggle 2505 returns to a neutral (OFF) position when the toggle 2505 is released. When the switch toggle 2505 is moved to the DOWN position, the corresponding fender finder assembly 2001 retracts, so long as the switch toggle 2502 is held in the DOWN position.

Switch 2503, having actuator toggle 2506, serves a similar purpose for the fender finder assembly 2001 disposed proximate the right front extremity of the vehicle. When the actuator toggle 2506 is moved to the UP position, the corresponding standard 2003 of the right-side fender finder assembly 2001 extends, and when the toggle 2506 is moved into the DOWN position, the right-side fender finder 2001 retracts.

Of course, the control switch arrangement illustrated in FIGS. 25 and 26 is only exemplary, and other suitable arrangements could also be devised. For example, a single switch may be devoted to UP and DOWN control of the fender finders 2001, with a second switch designed to select which fender finder (either left or right side) is being controlled. Wiring between the switches 2502, 2503 and the fender finder assemblies 2001 is preferably carried by a cable assembly that is not illustrated in the drawings.

As noted above in conjunction with the description of FIG. 23, extension and contraction of the standard 2003 of the fender finder 2001 is controlled remotely through actuation of the electric motor 2302, and it can be appreciated from the discussion relating to FIGS. 25 and 26 that the switches 2502, 2503 provide the remote control of extension and retraction.

One of ordinary skill in the applicable art will readily apprehend the operation of the electrically operated drive assembly 2002. Control of extension and retraction of the standard 2003 simply requires application of DC (direct current) voltage to the drive motor 2302 in a first direction for extension of the standard 2003, and reversal of the direction of voltage application for retraction of the standard 2003. Switches 2502, 2503 can easily be configured to accomplish connection of the DC supply in the proper directions to control desired direction of operation of the standards 2003, and consequently, this is not illustrated in the drawings.

Complete control of the fender finder standards 2003 is preferably provided through the switches 2502, 2503 alone. For example, switches 2502 and 2503 provide continuous control over the degree of extension of the standards 2003, such that the standards may be extended to any desired length between complete retraction and complete extension simply by placing the corresponding switch in the OFF position when the desired degree of standard extension has been reached. In a preferred embodiment of the invention, the fender finder standards 2003 remain in their operator-selected positions regardless of the operation of the vehicle ignition switch.

Of course, modifications to the preferred operation of the system are still within the spirit and scope of the invention. For example, it is a simple matter to include an automatic retraction feature that would act to retract the fender finder standards 2003 completely when the vehicle ignition switch is turned off. Furthermore, it is straightforward to include a memory feature that would restore the fender finder standards 2003 to their previous, extended positions when the vehicle ignition switch is turned on once again.

In fact, it is also possible to include user memory that stores favored positions for the fender finder standards for a variety of users, and automatically positions the fender finder standards 2003 to the stored position when that user's ID (identification) number is selected. A memory feature of this kind is already included in many vehicles so that electric seat positions and rear view mirror positions can be retained in memory. One of ordinary skill in the art will readily understand how to adapt known systems of this type for use with the fender finder implementation described above.

There has been described herein a fender finder that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A locating device constructed and arranged for installation on a vehicle, the locating device comprising:
an electrically operated drive assembly positioned proximate a vehicle extremity;
a standard portion operably installed in the electrically operated drive assembly; and
a dedicated control switch installed within the vehicle and electrically interconnected with the electrically operated drive assembly;
wherein operation of the dedicated control switch by a vehicle operator provides continuously variable extension of the standard portion to position the standard at an optimum height above the vehicle, thus aiding the operator in determining location of the vehicle extremity.

2. The locating device of claim 1, wherein the electrically operated drive assembly is disposed substantially within the vehicle body, proximate the vehicle extremity to be located.

3. The locating device of claim 2, wherein a portion of the electrically operated drive assembly extends through an opening in the vehicle body proximate the vehicle extremity to be located.

4. The locating device of claim 1, wherein the standard portion comprises a telescoping standard.

5. The locating device of claim 4, wherein the telescoping standard is coupled to the electrically operated drive assembly via a flexible portion.

6. The locating device of claim 5, wherein the flexible portion is affixed, proximate a first end, to an innermost section of the telescoping standard.

7. The locating device of claim 5, wherein the flexible portion is coupled to a drive gear internal to the electrically operated drive assembly.

8. The locating device of claim 7, in combination with the flexible portion and the drive gear, wherein the flexible portion is coupled to the drive gear by mating gear teeth on the flexible drive portion and the drive gear.

9. The locating device of claim 1, wherein the standard portion comprises a one-piece standard.

10. The locating device of claim 9, wherein the one-piece standard is coupled to the electrically operated drive assembly via a flexible portion.

11. The locating device of claim 9, wherein the one-piece standard is coupled to the electrically operated drive assembly via a pair of opposing drive rollers.

12. The locating device of claim 11, wherein the electrically operated drive assembly further comprises a pair of opposing guide rollers in operational contact with the single-piece standard.

13. The locating device of claim 12, wherein the one-piece standard further comprises a stop feature constructed and arranged to contact the guide rollers to forestall over-extension of the standard.

14. The locating device of claim 1, wherein the dedicated control switch comprises a three-position control switch.

15. The locating device of claim 14, wherein the three-position control switch includes a first position that actuates the electrically operated drive assembly in a first direction, extending the standard portion outwardly from the electrically operated drive assembly.

16. The locating device of claim 15, wherein the three-position control switch includes a second position that actuates the electrically operated drive assembly in a second direction, retracting the standard portion in a direction toward the electrically operated drive assembly.

17. A locating device constructed and arranged for installation on a vehicle, the locating device comprising:
an electrically operated drive assembly positioned proximate a vehicle extremity and disposed substantially within the vehicle body;
a telescoping standard portion operably installed in the electrically operated drive assembly, and coupled thereto via a flexible portion affixed to an innermost section of the telescoping standard; and
a dedicated control switch installed within the vehicle and electrically interconnected with the electrically operated drive assembly;
wherein operation of the dedicated control switch by a vehicle operator provides continuously variable extension of the standard portion to position the standard at an optimum height above the vehicle, thus aiding the operator in determining location of the vehicle extremity.

18. The locating device of claim 17, wherein the dedicated control switch comprises a three-position control switch including a first position that actuates the electrically operated drive assembly in a first direction, extending the standard portion outwardly from the electrically operated drive assembly, and a second position that actuates the electrically operated drive assembly in a second direction, retracting the standard portion in a direction toward the electrically operated drive assembly.

19. A locating device constructed and arranged for installation on a vehicle, the locating device comprising:
an electrically operated drive assembly positioned proximate a vehicle extremity and disposed substantially within the vehicle body;
a single-piece standard portion operably installed in the electrically operated drive assembly, and coupled thereto via a pair of opposing drive rollers; and
a dedicated control switch installed within the vehicle and electrically interconnected with the electrically operated drive assembly;
wherein operation of the dedicated control switch by a vehicle operator provides continuously variable extension of the standard portion to position the standard at an optimum height above the vehicle, thus aiding the operator in determining location of the vehicle extremity.

20. The locating device of claim 19, wherein the dedicated control switch comprises a three-position control switch including a first position that actuates the electrically operated drive assembly in a first direction, extending the standard portion outwardly from the electrically operated drive assembly, and a second position that actuates the electrically operated drive assembly in a second direction, retracting the standard portion in a direction toward the electrically operated drive assembly.
